(19) United States
(12) Patent Application Publication
(10) Pub. No.: US 2026/0056416 A1
(43) Pub. Date: Feb. 26, 2026

(54) OPTICAL IMAGING SYSTEM AND HEAD-MOUNTED DISPLAY DEVICE

(71) Applicant: MATRIXED REALITY TECHNOLOGY CO., LTD., Wuxi (CN)

(72) Inventors: Donglong LIN, Beijing (CN); Bing XIAO, Beijing (CN)

(21) Appl. No.: 19/105,349

(22) PCT Filed: Aug. 23, 2023
(86) PCT No.: PCT/CN2023/114542

§ 371 Date: Feb. 21, 2025

(30) Foreign Application Priority Data
Aug. 23, 2022 (CN) 202211015173.1

(51) Int. Cl. G02B 27/01

(52) U.S. Cl. CPC G02B 27/0176; G02B 2027/0178

(57) ABSTRACT

Embodiments of the present disclosure disclose an optical imaging system. A specific implementation is: an optical imaging system including: a spacer, a display screen, and a lens. The spacer has a central through hole. The spacer is provided with a first side and a second side on two sides in a thickness direction thereof. The second side has a main support surface and an avoidance surface extending from the main support surface to an edge defining the central through hole. The display screen is arranged on the first side. The lens has a main lens body and an outer edge portion connected to the main lens body. The main lens body is provided with outer convex portions on both sides in a thickness direction thereof, and an outer surface of each outer convex portion is at least partially higher than an outer surface of the outer edge portion on a corresponding side.

### CROSS-REFERENCES TO RELATED APPLICATIONS

This patent application is a national phase entry under 35 USC § 371 of International Application PCT/CN2023/114542, filed on Aug. 23, 2023, which claims the benefit of and priority to Chinese Patent Application No. 202211015173.1, filed on Aug. 23, 2022. The disclosures of the aforementioned applications are hereby incorporated by reference in their entireties.

### FIELD

The present disclosure relates to the field of optical imaging technology, in particular to an optical imaging system and a head-mounted display device.

### BACKGROUND

Currently, an optical imaging system for a head-mounted display device typically includes a display screen, optical elements, and a bracket that carries the aforementioned components. A lens usually needs to be provided in the optical imaging system to correct a field curvature. Generally, a lens is fit to a light exit surface of the display screen, or a lens is arranged near the light exit surface of the display screen. To meet the optical design, upper and lower surfaces of some lenses are both convex surfaces. This type of lens is not convenient for adhering. In order to keep the accuracy of the optical imaging system, the assembly of this type of lens needs to be designed.

### SUMMARY

Embodiments of the present disclosure provide an optical imaging system.

To achieve the embodiments of the present disclosure provides the following embodiments. An optical imaging system provided in the present disclosure includes: a spacer, a display screen, and a lens. The spacer has a central through hole. The spacer is provided with a first side and a second side on two sides in a thickness direction thereof. The second side has a main support surface and an avoidance surface extending from the main support surface to an edge defining the central through hole. The display screen is arranged on the first side. The lens has a main lens body and an outer edge portion connected to the main lens body. The main lens body is provided with outer convex portions on both sides in a thickness direction thereof, and an outer surface of each outer convex portion is at least partially higher than an outer surface of the outer edge portion on a corresponding side; a side of the outer edge portion close to the display screen is positioned and fit to the main support surface; and a gap is defined between an outer surface of the outer convex portion close to the display screen and the avoidance surface.

The embodiments of the present disclosure is further described in detail below in conjunction with the accompanying drawings and embodiments.

### BRIEF DESCRIPTION OF THE DRAWINGS

The drawings constituting a part of the specification describe embodiments of the present disclosure, and together with the description, serve to explain the principle of the present disclosure.

With reference to the accompanying drawings, the present disclosure can be understood more clearly according to the following detailed description:

FIG. 1 shows a schematic diagram of an optical imaging system provided in embodiments of the present disclosure assembled to a frame body of a head-mounted display device.

FIG. 2 shows a cross-sectional view of an optical imaging system provided in embodiments of the present disclosure.

FIG. 3 shows an exploded view of an optical imaging system provided in embodiments of the present disclosure.

FIG. 4 shows a structural diagram of a bracket of an optical imaging system provided in embodiments of the present disclosure.

FIG. 5 shows a stereoscopic structural diagram of a spacer of an optical imaging system provided in embodiments of the present disclosure.

FIG. 6 shows a cross-sectional diagram of a first type of spacer of an optical imaging system provided in embodiments of the present disclosure.

FIG. 7 shows a schematic diagram illustrating an avoidance surface of a first type of spacer of an optical imaging system provided in embodiments of the present disclosure reflecting a light ray emitted by a display screen.

FIG. 8 shows a partial enlarged view of FIG. 7.

FIG. 9 shows a schematic diagram illustrating an avoidance surface of a spacer of an optical imaging system provided in embodiments of the present disclosure not reflecting a light ray emitted by a display screen.

FIG. 10 shows a partial enlarged view of FIG. 9.

FIG. 11 shows a schematic diagram of a maximum angle α by which a light ray emitted by a display screen deviates from a normal line of the display screen.

FIG. 12 shows a side view of a lens of an optical imaging system provided in embodiments of the present disclosure.

FIG. 13 shows a bottom view of a second type of spacer of an optical imaging system provided in embodiments of the present disclosure.

FIG. 14 shows a cross-sectional view of a second type of spacer of an optical imaging system provided in embodiments of the present disclosure.

FIG. 15 shows an assembly structural diagram of a second type of spacer, a lens and a display screen of an optical imaging system provided in embodiments of the present disclosure.

FIG. 16 shows a schematic diagram illustrating a second type of spacer of an optical imaging system provided in embodiments of the present disclosure reflecting a light ray emitted by a display screen.

FIG. 17 shows a principle diagram of an optical imaging system provided in embodiments of the present disclosure.

It is to be noted that these drawings and text description are not intended to limit the scope of conception of the present disclosure in any way, but to explain the concepts of the present disclosure by referring to the embodiments.

### DETAILED DESCRIPTION OF THE DISCLOSURE

To make the embodiments of the present disclosure clearer, the embodiments will be described clearly and completely with reference to the drawings in the embodiments of the present disclosure. The following embodiments are used for illustrating the present disclosure, but not limiting the scope of the present disclosure.

In description of the present disclosure, it should be noted that orientation or location relations denoted by the terms “upper”, “lower”, “inner”, “outer”, etc. are orientation or location relations based on illustration in the drawings, are only intended to facilitate describing the present disclosure and simplify description, instead of indicating or implying the denoted apparatuses or elements must have specific orientations and are constructed and operated in specific orientations, and thus they should not be construed as limiting the present disclosure.

In description of the present disclosure, it should be noted that unless otherwise explicitly specified and defined, the terms “mount” and “connect” should be construed broadly. For example, such a term may denote fixed connection, or detachable connection, or integrated connection; mechanical connection, or electric connection; direction connection, or connection via an intermediate medium. Specific meanings of the above-mentioned terms in the present disclosure may be construed according to specific conditions.

Referring to FIGS. 2, 3, and 5, embodiments of the present disclosure provide an optical imaging system 100 including: a spacer 1, a display screen 2, and a lens 3. The spacer 1 has a central through hole 11. The lens 3 and the display screen 2 are separately provided on two sides in a thickness direction of the spacer 1.

The display screen 2 of the optical imaging system 100 can emit light rays d capable of forming an image. For example, the size of the lens 3 may be larger than that of the display screen 2 and all light emitted by the display screen 2 can pass through the lens 3 for field curvature correction. It may be appreciated that after the display screen 2 and the lens 3 are mounted to the spacer 1, an outer edge of an orthogonal projection of the display screen 2 on an upper surface of the lens 3 may be smaller than an outer edge of the lens 3.

The lens 3 may have a main lens body 31 and an outer edge portion 32 connected to the main lens body 31. The main lens body 31 is provided with outer convex portions on both sides in a thickness direction thereof. The outer edge portion 32 can be supported on the spacer 1. If the outer edge portion 32 of the lens 3 and the display screen 2 are located on a same side of the spacer 1, then in order to allow the outer convex portion on a side of the main lens body 31 of the lens 3 away from the display screen 2 to pass through the central through hole 11 of the spacer 1, in an example where the size of the lens 3 is larger than that of the display screen 2, the spacer 1 alone cannot provide a suitable structure for supporting the display screen 2.

In embodiments of the present disclosure, the lens 3 and the display screen 2 are respectively mounted on the two sides of the spacer 1, to facilitate the spacer 1 receiving the lens 3 and the display screen 2 respectively on the two sides in the thickness direction, thus simplifying the assembly structure.

The optical imaging system 100 provided in embodiments of the present disclosure may be any one of VR (Virtual Reality), AR (Augmented Reality), and MR (Mixed Reality) optical imaging systems.

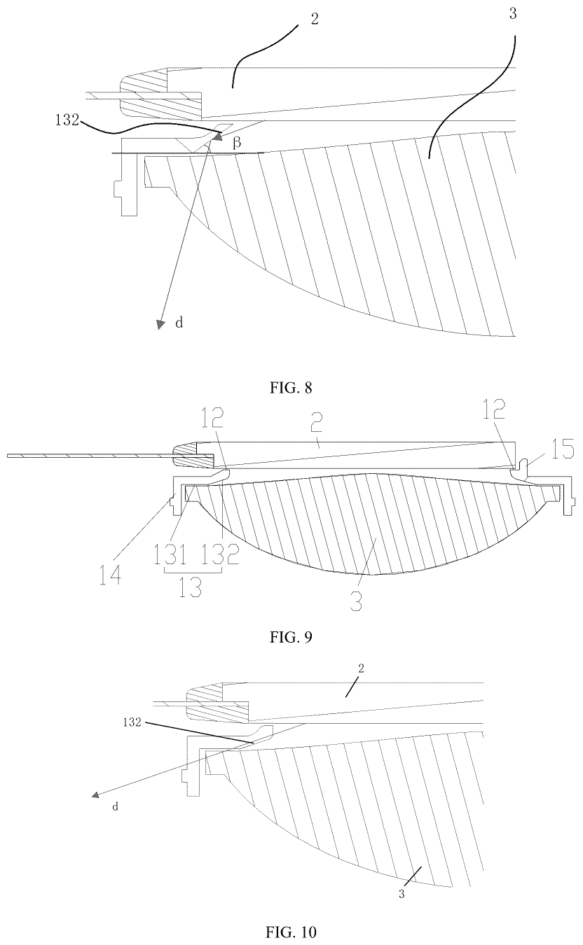

In one embodiment, referring to FIGS. 9, 12 and 15, the spacer 1 is provided with a first side 12 and a second side 13 on the two sides in the thickness direction thereof, and the display screen 2 may be arranged on the first side 12. The second side 13 may have a main support surface 131 and an avoidance surface 132 extending from the main support surface 131 to an edge defining the central through hole 11. The lens 3 has a main lens body 31 and an outer edge portion 32 connected to the main lens body 31. The main lens body 31 is provided with outer convex portions on both sides in a thickness direction thereof, and an outer surface of each of the outer convex portions may be at least partially higher than an outer surface of the outer edge portion 32 on a corresponding side. A side of the outer edge portion 32 close to the display screen 2 is positioned and fit to the main support surface 131, and a gap is provided between an outer surface of the outer convex portion close to the display screen 2 and the avoidance surface 132.

In this embodiment, a peripheral side of the lens 3 is provided with the outer edge portion 32, which facilitates positioning to and fitting the lens to the main support surface 131, and the main lens body 31 can directly face the display screen 2 and the main lens body 31 is located directly under the display screen 2. That is, the outer edge of the orthogonal projection of the display screen 2 on the upper surface of the lens 3 conforms to the main lens body 31 or falls completely into the main lens body 31. In embodiments of the present disclosure, the lens 3 is a biconvex lens 3, and the outer surface of the outer convex portion of the lens 3 close to the display screen 2 is an outer convex surface. In order to avoid affecting the assembly of the lens 3 due to interference between the outer surface of the outer convex portion and the second side 13, in embodiments of the present disclosure, the avoidance surface 132 is provided on an inner side of the main support surface 131, and the avoidance surface 132 as a whole extends toward the first side 12, to avoid the outer convex portion on the corresponding side of the lens 3. In a state where the outer edge portion 32 of the lens 3 is positioned and fit to the main support surface 131, there is still a gap between the outer surface of the outer convex portion of the lens 3 close to the display screen 2 and the avoidance surface 132, and there is no interference between the avoidance surface 132 and the lens 3, which is convenient for the lens 3 to be smoothly assembled to the spacer 1, and ensures the assembly precision between the lens 3 and the spacer 1.

Exemplarily, the main support surface 131 and the avoidance surface 132 may be non-flush with each other in the thickness direction of the spacer 1. It may be appreciated that the term “non-flush” here may be understood as meaning that the two surfaces are not on a same flat surface. Exemplarily, it is possible that a certain included angle is formed between the main support surface 131 and the avoidance surface 132, and the avoidance surface 132 may be a flat surface. It is also possible that the main support surface 131 and the avoidance surface 132 are located in different planes. Exemplarily, the main support surface 131 and the avoidance surface 132 may be continuously adjacent portions.

In one embodiment, referring to FIGS. 12, 13, 14 and 15, the lens 3 may be provided with outer edge portions 32 at two ends in a length direction thereof. The spacer 1 may be substantially rectangular. The spacer 1 may include two length plate portions and two width plate portions. The two width plate portions are respectively located at two ends of each of the two length plate portions, and each of the two width plate portions is connected to the two length plate portions. A main support surface 131 and an avoidance surface 132 may be provided only on a side of each of the two width plate portions away from the display screen 2, and the avoidance surface 132 is located on a side close to the central through hole 11. In assembly, the two outer edge portions 32 at the two ends of the lens 3 are respectively supported on the main support surfaces 131 on the two width plate portions, and edges of the two length plate portions on a side close to the central through hole 11 may be fit to or in clearance fit with the lens 3.

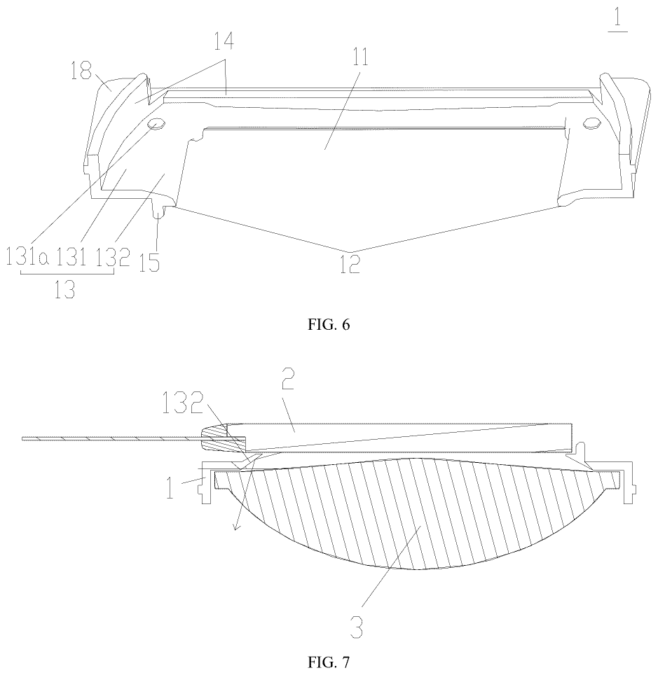

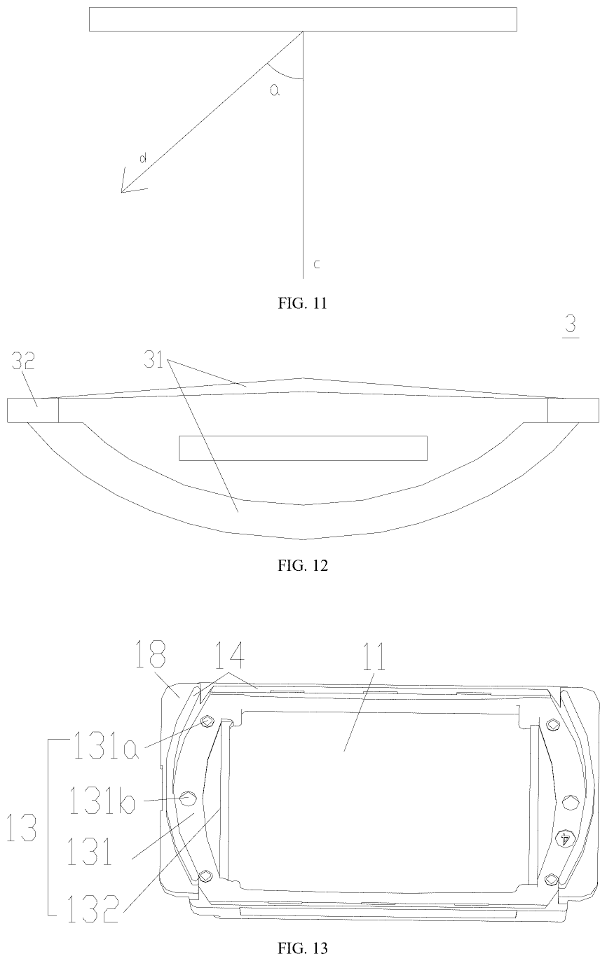

In one embodiment, referring to FIGS. 6, 7, 8, 9, and 10, the avoidance surface 132 may be an inclined surface extending from the main support surface 131 toward the first side 12. Referring to FIG. 11, a maximum angle by which a light ray d emitted by the display screen 2 deviates from a normal line c of the display screen 2 is a. Referring to FIG. 8, an included angle between the inclined surface and a plane in which the display screen 2 is located is B. In some embodiments of the present disclosure, β≤90-α is defined. As shown, the display screen 2 is substantially parallel to the main support surface 131 of the spacer, and thus, an included angle between the plane of the illustrated main support surface 131 and the inclined surface may also be denoted as B.

In some embodiments of the present disclosure, referring to FIGS. 7 and 8, because the spacer 1 is provided between the display screen 2 and the lens 3, there is a possibility that a light ray d emitted by the display screen 2 arrives at the avoidance surface 132 on the spacer 1 and then is reflected to the lens 3, and a human eye can see a stray light ray d formed by the light ray reflected from the spacer 1, which seriously affects a user's visual experience. In order to solve this problem, an angle of inclination of the avoidance surface 132 is designed in some embodiments of the present disclosure. Referring to FIGS. 9 and 10, in the case of β≤90-α, if a light ray d emitted by the display screen 2 deviating from the normal line c of the display screen 2 by a maximum angle is parallel to or greater than the angle of inclination of the inclined surface, none of light rays d emitted by the display screen 2 can reach the inclined surface. No light ray is reflected from the avoidance surface 132, thus avoiding the formation of a stray light ray d, so a user's visual experience is not affected.

In one embodiment, referring to FIGS. 12, 13, 14, 15, and 16, the avoidance surface 132 has multiple step surfaces 1321. Each of the step surfaces 1321 is perpendicularly to the display screen 2. The step surfaces 1321 are arranged successively at intervals in a direction from the main support surface 131 to the central through hole 11.

It may be appreciated that the number and sizes of the step surfaces may be configured depending on the size of the convex portion of the lens 3. For example, one, two or more step surfaces may be provided. In embodiments with multiple step surfaces, the sizes of the step surfaces may be different.

It is now assumed that an included angle between the outer surface of the outer convex portion of the lens 3 close to the display screen 2 and the plane in which the display screen 2 is located is 0. For some surface light sources such as OLEDs (Organic Light-Emitting Diodes) at present, the value of a is large, and may be greater than 89 degrees. To avoid the convex portion of the lens 3, the included angle β between the inclined surface and the plane where the display screen 2 is located needs to be greater than 0, and the value of β is hardly smaller than 1 degree. In order to solve the problem, the avoidance surface 132 is improved by providing multiple step surfaces 1321 on the avoidance surface 132 in some embodiments of the present disclosure. Each of the step surfaces 1321 may be substantially perpendicular to the display screen 2, and adjacent step surfaces 1321 may be connected to each other by a horizontal surface substantially parallel to the display screen 2. A light ray d emitted by the display screen 2 can be only directly incident on the step surfaces 1321 on the spacer 1 that are parallel to the normal line c of the display screen 2. Referring to FIG. 16, a light ray d is incident on each step surface 1321 of the spacer 1 at an angle approximately perpendicular to each step surface 1321, and reflected at an angle approximately perpendicular to each step surface 1321. The light ray is reflected approximately in parallel, making it difficult to enter the user's eye vertically through the lens 3, so substantially no stray light ray d capable of entering the human eye can be formed, and a user's visual experience is not affected.

In some embodiments, vertexes are formed between the horizontal surfaces and the step surfaces 1321 connected thereby. Assuming that an included angle between the outer surface at a location of the vertexes and the plane where the display screen 2 is located is R, then R≤90-α is met. In this way, a light ray d emitted by the display screen 2 is not reflected at the location of the vertexes, so the user does not see a stray light ray d formed at the spacer 1.

In one embodiment, referring to FIG. 15, the step surfaces 1321 are arranged successively at intervals in a direction from the main support surface 131 to the first side 13. Extension lengths of step surfaces 1321 adjacent to the display screen 2 are greater than extension lengths of step surface 1321 away from the display screen 2.

In this embodiment, the closer a step surface 1321 is to the display screen 2, the closer a light ray d reflected by the step surface 1321 is to the display screen 2 after a light ray d incident on the step surface, and the less likely it is to enter the human eye. The farther a step surface 1321 is from the display screen 2, the more likely a light ray d reflected by the step surface 1321 is to enter the human eye after a light ray d incident on the step surface. Therefore, in some embodiments of the present disclosure, by reducing extension lengths of step surfaces 1321 farther from the display screen 2, stray light rays d can be reduced or avoided to the human eye.

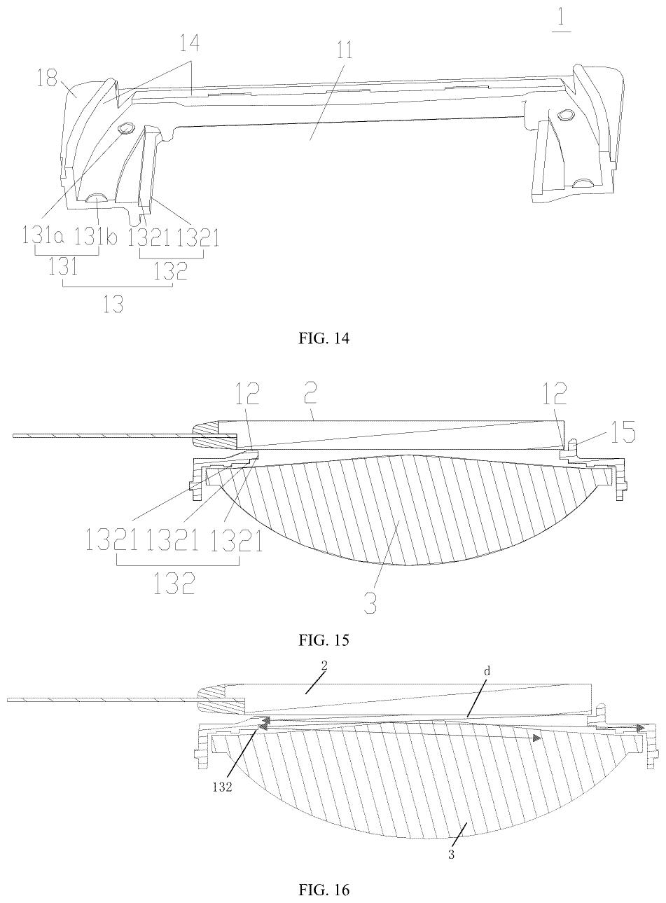

In one embodiment, referring to FIGS. 13 and 14, the main support surface 131 is provided with bumps 131a. The bumps 131a are supported on the outer edge portion 32 of the lens 3.

Considering that one surface is difficult to be flush with another one when the two surfaces are in contact, which is not conducive for accurate assembly. In some embodiments of the present disclosure, the outer edge portion 32 of the lens 3 is designed to have a flat surface on a side facing the main support surface 131. Bumps 131a are provided on each main support surfaces 131, and the bumps 131a may be used to position and support the lens 3 to avoid face-face contact between the protruding outer edge portion 32 of the lens 3 and the spacer 1, thus reducing the difficulty of assembly, and improving the accuracy of assembly.

As mentioned above, the lens 3 may be provided with outer edge portions 32 at two ends in a length direction thereof. The spacer 1 may be substantially rectangular in shape. The spacer 1 may include two length plate portions and two width plate portions. The two width plate portions are respectively located at two ends of each of the two length plate portions, and each of the two width plate portions is connected to the two length plate portions. A main support surface 131 and an avoidance surface 132 may be provided only on a side of each of the two width plate portions away from the display screen 2, and the avoidance surface 132 is located on a side close to the central through hole 11. Two bumps 131a may be provided on the main support surface 131 of each of the two width plate portions on two sides of the spacer 1. The two bumps 131a on one side of the spacer 1 are fit to the outer edge portion 32 on one side of the lens 3, and the two bumps 131a on the other side of the spacer 1 are fit to the outer edge portion 32 on the other side of the lens 3.

The main support surface 131 of each width plate portion may also be provided with an assembly marking portion for marking an attitude and position of the spacer 1, to provide position information to an assembling machine to facilitate the assembling machine performing an accurate assembling operation. The assembly marking portion improves the precision of assembly. Exemplarily, the assembly marking portion may include a circular hole 131b defined in the main support surface 131. The assembly marking portion may be provided at a position midway between the two bumps 131a on the same side of the spacer 1.

In one embodiment, referring to FIGS. 2 and 6, the second side 13 is provided with a first baffle 14, and a peripheral side end surface of the lens 3 is bonded and fixed to the first stop baffle 14.

First baffles 14 may be provided on the length plate portions on two sides of the spacer 1. The first baffles 14 may also be arranged on the length plate portions and the width plate portions. The first baffles 14 may form an enclosed ring in an enclosing manner, and the first baffles 14 are disposed outside a periphery of the central through hole 11, making it convenient for the first baffles 14 to be bonded and fixed to end surfaces at a periphery of the lens 3.

The lens 3 may be bonded and fixed to the spacer 1 by an adhesive. In one embodiment, a side of the lens 3 facing the display screen 2 is not coated with an adhesive, which avoids affecting a user's visual experience when light rays emitted by the display screen 2 are incident on adhesive coated portions. The lens 3 is coated with the adhesive only between the peripheral side end surfaces and the first baffles 14.

In one embodiment, referring to FIGS. 2 and 5, the first side 12 is provided with a second baffle 15, and a peripheral side end surface of the display screen 2 is bonded and fixed to the second baffle 15.

In this embodiment, gaps between the display screen 2 and the second baffle 15 are used for applying an adhesive and the display screen 2 and the second baffle 15 are bonded and fixed by the adhesive. In one embodiment, a side of the display screen 2 facing the central through hole 11 is not coated with an adhesive, which avoids affecting emission of light rays d from the display screen 2.

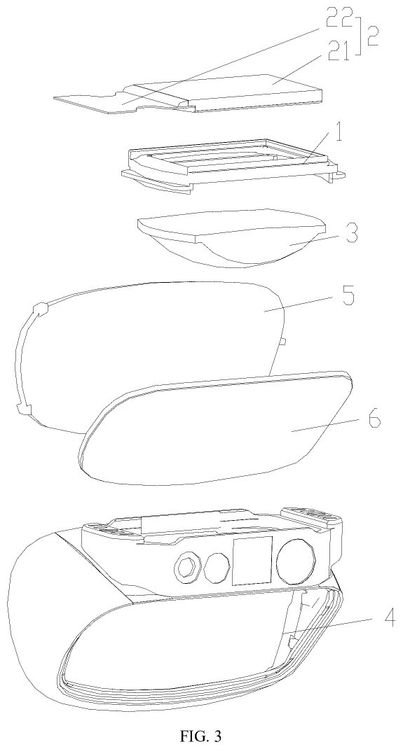

In one embodiment, referring to FIGS. 3 and 5, the second baffle 15 define, in an enclosing manner, a mounting groove 16 and an avoidance portion 17 in communication with the mounting groove 16. The display screen 2 includes a main screen body 21 and a circuit board 22 connected to the main screen body 21. The main screen body 21 is embedded in the mounting groove 16, and the circuit board 22 is passed through the avoidance portion 17.

In this embodiment, the second baffle 15 are not an enclosed ring. The spacer 1 may be substantially rectangular in shape. The second baffle 15 may extend along three edges of the spacer 1 to define, in an enclosing manner, the mounting groove 16. The avoidance portion 17 is defined on a side not enclosed by the second baffle 15. The avoidance portion 17 can avoid the circuit board 22 of the display screen 2, which facilitates assembly of the display screen 2.

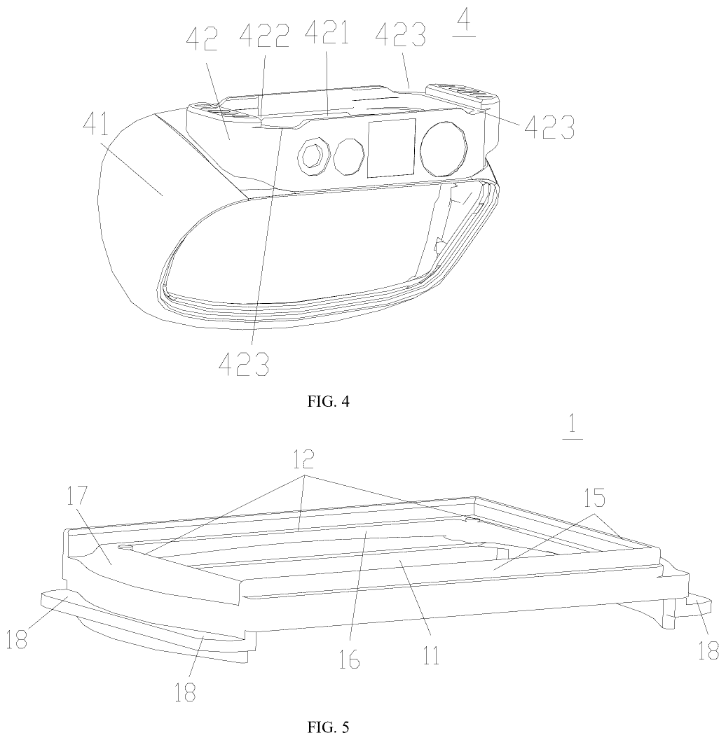

In one embodiment, referring to FIGS. 3 and 4, the optical imaging system 100 further includes a bracket 4, a reflective mirror 5, and a splitter 6. The reflective mirror 5 and the splitter 6 are both connected to the bracket 4. The bracket 4, the reflective mirror 5, and the splitter 6 enclose to define a cavity. The bracket 4 has a main casing 41 and a mounting base 42. The reflective mirror 5 and the splitter 6 are both connected to the main casing 41. The reflective mirror 5, the splitter 6, and the main casing 41 enclose to define a cavity. The mounting base 42 has a communication slot 421 in communication with the cavity. The spacer 1 is bonded and fixed to the bracket 4. The spacer 1 and the lens 3 mounted to the spacer 1 close the communication slot 421 and the cavity becomes a closed cavity.

In this embodiment, the optical imaging system 100 encloses a closed cavity. Dust impurities cannot enter the cavity, so the cavity can be kept in a clean state, and a user does not need to clean up the cavity, and there is no element causing stray light ray d in the cavity, which ensures a user's visual experience.

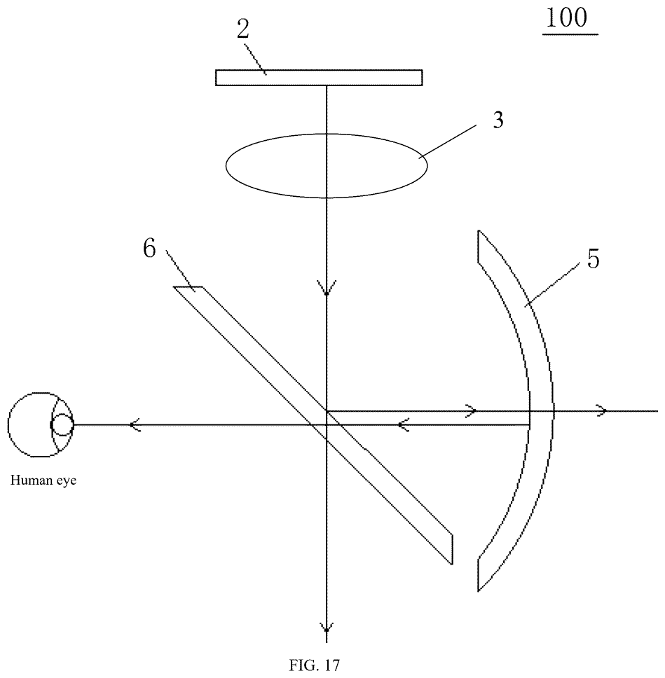

FIG. 17 shows a principle diagram of an optical imaging system 100 provided in embodiments of the present disclosure. The optical imaging system 100 includes a display screen 2 and an optical assembly. The optical assembly includes a lens 3, a reflective mirror 5 and a splitter 6 as described above. The display screen 2 is used to emit light rays d capable of forming an image. The optical assembly is used to change an optical path of the light rays d emitted by the display screen 2 to project the light rays d toward a direction of a first side of the display screen 2 and the light rays d can be projected into a user's eye to form an image in the eye of the user when a head-mounted display device provided with the optical imaging system 100 is worn on the head of the user. The display screen 2 can project a light ray d in a vertical direction. After the light ray d emitted from the display screen 2 passes through the lens 3, it can be refracted by the splitter 6, which projects the light ray d in a direction of a second side. The light ray d projected by the splitter 6 is reflected by the reflective mirror 5, which projects the light ray d in the direction of the first side. The light ray d can pass through the splitter 6 and be projected into the eye of the user when the user wears the head-mounted display device, thus forming a virtual image in the user's visual field. Wearing the head-mounted display device, the user sees both a real world and a virtual picture superposed to the real world. For example, a virtual cartoon character is placed on a table in the real world, or virtual images and videos, etc. are displayed in the visual field.

In one embodiment, referring to FIGS. 3 and 4, an inner wall defining the communication slot 421 is provided with a receiving step 422. Referring to FIGS. 5 and 2, the spacer 1 is provided with outer flanges 18. The lens 3 extends into the communication slot 421. The outer flanges 18 are supported on the mounting base 42, and peripheral side end surfaces of the spacer 1 are bonded and fixed to the mounting base 42.

In some embodiments of the present disclosure, the spacer 1 is directly lapped on a surface of the mounting base 42 by means of the outer flanges 18, which facilitates fine-tuning of the position of the spacer 1 and is conducive for precise assembly of the spacer 1. After the position of the spacer 1 is adjusted, an adhesive may be applied to a gap between a periphery of the spacer 1 and the mounting base 42 to bond and fix the spacer 1 to the mounting base 42. In some embodiments of the present disclosure, the receiving step 422 may be provided to receive the adhesive falling in a gluing process of the spacer 1 and the bracket 4, to avoid that the adhesive falls directly into the cavity inside the optical imaging system 100 and contaminates the splitter 6 and the reflective mirror 5 below.

In one embodiment, referring to FIG. 4, the mounting base 42 is substantially rectangular in shape, with the communication slot 421 defined in the middle of the mounting base 42. First edge protecting portions are respectively provided on two sides in a width direction of the mounting base 42, and second edge protecting portions are respectively provided on two ends in a length direction of the mounting base 42. The two second edge protecting portions and the two first edge protecting portions enclose the communication slot 421. Recessed notches 423 are provided at end positions where the first edge protecting portions are connected to the second edge protecting portions, i.e., a total of four recessed notches 423 are provided on the mounting base 42. Referring to FIG. 5, an outer flange 18 is provided at each of four corners of the spacer 1, and each of the four outer flanges 18 may be lapped on a corresponding recessed notch 423. The position of the spacer 1 may be finely adjusted along bottom surfaces of the recessed notches 423. Because the four outer flanges 18 are downwardly supported on the recessed notches 423, the entire spacer 1 is downwardly mounted in connection slots. The peripheral side end surfaces of the spacer 1 and the inner wall of the communication slot 421 of the mounting base 42 are located at a same height, and a gap is defined between the peripheral side end surfaces of the spacer 1 and the inner wall defining the communication slot 421, to facilitates applying the adhesive.

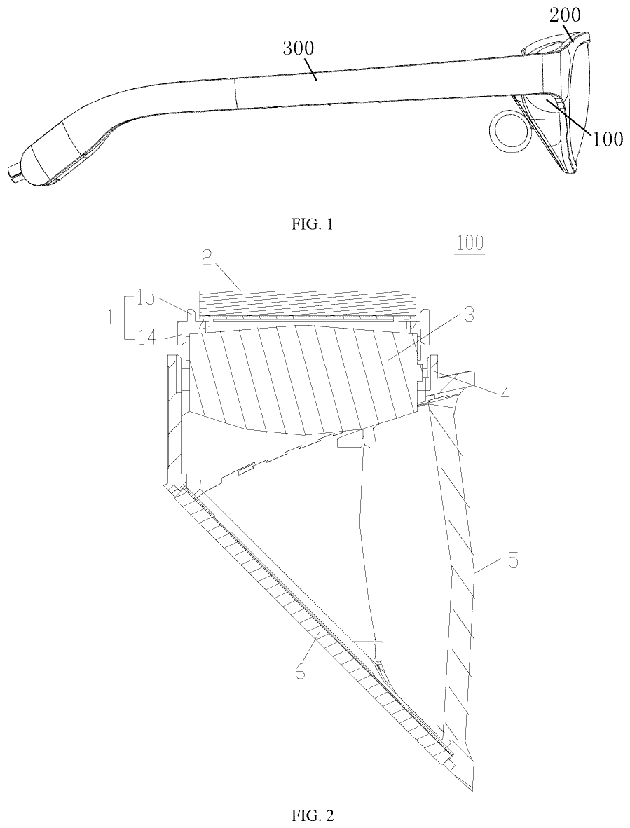

Referring to FIG. 1, a head-mounted display device may include a frame body 200 and temples 300 connected to the frame body 200. The second edge protecting portions may be connected to the frame body 200 by fasteners. Exemplarily, connecting holes for connection and fixation may be provided on both second edge protecting portions, and connection beams may be provided on the frame body 200. The fasteners may be passed through the connection beams and connected in the connection holes on the second edge protecting portions, to mount the optical imaging system 100 provided in embodiments of the present disclosure to the frame body 200.

It may be appreciated that in order to meet the optical design, the size of the outer convex portion on the side of the lens 3 close to the display screen 2 is larger than that of the outer convex portion on the side of the lens 3 away from the display screen 2.

Referring to FIGS. 7 to 10, in some embodiments, an included angle is formed between the main support surface 131 and the avoidance surface 132. As shown in FIGS. 7 and 8, the avoidance surface 132 extends all the way to the top, and the top surface adjoining the avoidance surface 132 is used to support the display screen 3, i.e., the avoidance surface extends to the top surface for supporting the display screen 3. As shown in FIGS. 9 and 10, the avoidance surface 132 does not extend to the top, and there is also a transition surface between the avoidance surface 132 and the top surface for supporting the display screen 3. An included angle is formed between the transition surface and the avoidance surface 132. In one embodiment, an included angle between the transition surface and the main support surface 131 is greater than an included angle between the avoidance surface 132 and the main support surface 131. In this way, the transition surface can also be used to prevent light rays emitted by the display screen 3 from entering a human eye.

In some embodiments of the present disclosure, there is provided an optical imaging system, which includes: a display screen; a lens having a main lens body and an outer edge portion connected to the main lens body, and the main lens body is provided with outer convex portions on both sides in a thickness direction thereof, and an outer surface of each outer convex portion is at least partially higher than an outer surface of the outer edge portion on a corresponding side; and a spacer disposed between the display screen and the lens, the spacer having a first side for supporting the display screen and a second side for supporting the lens, and the second side has a main support portion for supporting the outer edge portion, and an avoidance portion, with a gap being defined between the avoidance surface and the outer convex portion. In one embodiment, the spacer defines a through hole, through which a light exit surface of the display corresponds to the main lens body of the lens. It may be appreciated that the main support portion may have a main support surface, and the avoidance portion may have an avoidance surface.

In some embodiments of the present disclosure, there is provided a head-mounted display device, which includes: a frame body; temples connected to the frame body; and an optical imaging system connected to the frame body. The optical imaging system includes: a display screen; a lens having a main lens body and outer edge portions connected to the main lens body, and the main lens body is provided with outer convex portions on both sides in a thickness direction thereof, and the outer edge portions are located on two ends in a length direction of the lens; and a spacer arranged between the display screen and the lens, the spacer having a first side for supporting the display screen and a second side for supporting the lens, and a main support portion for supporting an outer edge portion, and an avoidance portion are provided at a position on the second side corresponding to each of the two ends of the lens, with a gap being defined between the avoidance surface and the outer convex portion.

The above description has been made for purposes of illustration and description. In addition, this description is not intended to limit the embodiments of the present disclosure to the forms disclosed herein. Although embodiments have been discussed above, certain variations, modifications, changes, additions, and sub-combinations thereof.

1. An optical imaging system, comprising:
a spacer having a central through hole and provided with a first side and a second side on two sides in a thickness direction of the spacer, the second side having a main support surface and an avoidance surface, and the avoidance surface extending from the main support surface to an edge defining the central through hole;
a display screen arranged on the first side; and
a lens having a main lens body and an outer edge portion connected to the main lens body, wherein the main lens body is provided with outer convex portions on both sides in a thickness direction thereof, and an outer surface of each outer convex portion is at least partially higher than an outer surface of the outer edge portion on a corresponding side; a side of the outer edge portion adjacent to the display screen is positioned and fit to the main support surface; and
a gap is defined between an outer surface of the outer convex portion adjacent to the display screen and the avoidance surface.

2. The optical imaging system according to claim 1, wherein the main support surface and the avoidance surface are non-flush with each other in the thickness direction of the spacer.

3. The optical imaging system according to claim 1, wherein the avoidance surface has a plurality of step surfaces, each of the step surfaces being arranged perpendicular to the display screen; and
the step surfaces are arranged successively at intervals in a direction from the main support surface to the central through hole.

4. The optical imaging system according to claim 3, wherein the step surfaces are arranged successively at intervals in a direction from the main support surface to the first side; and
wherein extension lengths of step surfaces adjacent to the display screen are greater than extension lengths of step surface away from the display screen.

5. The optical imaging system according to claim 1,
wherein an included angle is formed between the main support surface and the avoidance surface.

6. The optical imaging system according to claim 5, wherein the avoidance surface is configured in one of the following manners:
the avoidance surface extends to a top surface for supporting the display screen; and
a transition surface is formed between the avoidance surface and a top surface for supporting the display screen, an included angle is formed between the transition surface and the avoidance surface, and an included angle between the transition surface and the main support surface is greater than an included angle between the avoidance surface and the main support surface.

7. The optical imaging system according to claim 1, wherein the avoidance surface is an inclined surface extending from the main support surface toward the first side;
a maximum angle by which a light ray emitted by the display screen deviates from a normal line of the display screen is a first included angle; and
an included angle between the inclined surface and a plane in which the display screen is located is a second included angle,
wherein the second included angle is greater than or equal to a difference between 90 degrees and the first included angle.

8. The optical imaging system according to claim 1, wherein the main support surface is provided with a plurality of bumps, and the bumps are supported on the outer edge portion of the lens.

9. The optical imaging system according to claim 1, wherein the second side is provided with a first baffle; and
a peripheral side end surface of the lens is bonded and fixed to the first baffle.

10. The optical imaging system according to claim 1, wherein the first side is provided with a second baffle; and
a peripheral side end surface of the display screen is bonded and fixed to the second baffle.

11. The optical imaging system according to claim 10, wherein the second baffle defines, in an enclosing manner, a mounting groove and an avoidance portion in communication with the mounting groove;
the display screen comprises a main screen body and a circuit board connected to the main screen body; and
the main screen body is embedded in the mounting groove, and the circuit board is passed through the avoidance portion.

12. The optical imaging system according to claim 1, further comprising a bracket, a reflective mirror, and a splitter, wherein
the reflective mirror and a splitter are both connected to the bracket, and the bracket, the reflective mirror, and the splitter enclose a cavity;
the bracket has a mounting base, and the mounting base has a communication slot in communication with the cavity; and
the spacer is bonded and fixed to the bracket, and the spacer and the lens mounted to the spacer enclose the communication slot.

13. The optical imaging system according to claim 12, wherein an inner wall defining the communication slot is provided with a receiving step;
the spacer is provided with an outer flange; the lens extends into the communication slot; the outer flanges is supported on the mounting base; and a peripheral side end surface of the spacer is bonded and fixed to the mounting base.

14. The optical imaging system according to claim 1, wherein the main support surface is further provided with an assembly marking portion for marking an attitude and position of the spacer.

15. (canceled)

16. An optical imaging system, comprising:
a display screen;
a lens having:
a main lens body provided with outer convex portions on both sides in a thickness direction of the main lens body, and
an outer edge portion connected to the main lens body, an outer surface of each outer convex portion being at least partially higher than an outer surface of the outer edge portion on a corresponding side; and
a spacer arranged between the display screen and the lens and having:
a first side for supporting the display screen, and
a second side for supporting the lens and having a main support portion for supporting the outer edge portion, and an avoidance portion, with a gap being defined between the avoidance surface and the outer convex portion.

17. The optical imaging system according to claim 16, wherein the spacer defines a through hole, through which a light exit surface of the display corresponds to the main lens body of the lens.

18. The optical imaging system according to claim 16, wherein the main support portion has a main support surface, and the avoidance portion has an avoidance surface

19. The optical imaging system according to claim 18, wherein an included angle is formed between the main support surface and the avoidance surface.

20. A head-mounted display device, comprising:
a frame body;
temples connected to the frame body; and
an optical imaging system connected to the frame body, comprising:
a display screen;
a lens having a main lens body and outer edge portions connected to the main lens body, the main lens body being provided with outer convex portions on both sides in a thickness direction thereof, and the outer edge portions being located on two ends in a length direction of the lens; and
a spacer arranged between the display screen and the lens, the spacer having a first side for supporting the display screen and a second side for supporting the lens, and a main support portion for supporting an outer edge portion, and an avoidance portion are provided at a position on the second side corresponding to each of the two ends of the lens, with a gap being defined between the avoidance surface and the outer convex portion.
